(19) United States
(12) Patent Application Publication
(10) Pub. No.: US 2009/0022648 A1
(43) Pub. Date: Jan. 22, 2009

(54) Induction fullerene producing device and producing method and induction fullerene

(76) Inventors: Rikizo Hatakeyama, Miyagi (JP); Kuniyoshi Yokoo, Miyagi (JP); Takamichi Hirata, Miyagi (JP); Yasuhiko Kasama, Miyagi (JP); Kenji Omote, Miyagi (JP)

Correspondence Address: YOUNG & THOMPSON, 209 Madison Street, Suite 500, ALEXANDRIA, VA, 22314, US

(21) Appl. No.: 11/659,201

(22) PCT Filed: Aug. 4, 2005
(86) PCT No.: PCT/JP05/14324

§ 371 Date: Oct. 7, 2008

(30) Foreign Application Priority Data
Aug. 4, 2004 (JP) 2004-228125

(51) Int. Cl. C01B 21/082; B01J 19/08; C01B 31/00

(52) U.S. Cl. 423/384; 204/157.44; 422/186.04; 423/445 B; 977/734

(57) ABSTRACT

A device and a method capable of producing induction fullerene with high yield are provided. Nitrogen gas being an object to be induced is introduced into a plasma flow producing chamber and a high-temperature flow forming chamber to form a high-temperature plasma flow consisting of nitrogen ions and electrons. A negative voltage is applied to a grid 105 to keep low electron energy in the high-temperature plasma flow. Then by making electrons collide with fullerene introduced from a fullerene sublimating oven 107, electrons are bonded to the fullerene and thereby the fullerene is ionized. A recovering cylinder 112 is disposed in an induction fullerene accumulating chamber so as to enclose a plasma flow. In this fullerene accumulating chamber, induction fullerene such as nitrogen-substitution hetero fullerene and nitrogen-included fullerene is produced and deposited in the recovering chamber 112.

### TECHNICAL FIELD

The present invention relates to a device and a method for producing induction fullerene such as hetero fullerene and included fullerene being expected to be applied to superconductive materials, non-linear optical materials, quantum computers and the like, and to induction fullerene. Particularly, it attempts to produce induction fullerene with high yield by providing a depositing substrate being in contact with a plasma flow.

### BACKGROUND ART

As a method of producing included fullerene being one of induction fullerenes there is a method using a plasma technique. That is, this method forms a high-temperature plasma flow containing gas atoms to be included, injects fullerene vapor to the high-temperature plasma flow and thereby generates included fullerene. And this is a method of making the included fullerene deposit on a depositing substrate disposed at the downstream side of the plasma flow.

### DISCLOSURE OF THE INVENTION

### Problem to be Solved by the Invention

Thus, such a method generates a high-temperature plasma flow, in which it makes gas atoms and fullerene ionized in reverse polarities to each other react with each other. However, there is a problem that the yield of included fullerene recovered from a depositing substrate is very low.

An object of the present invention is to provide a device and a method of producing induction fullerene with high yield.

### Means for Solving the Problem

An induction fullerene producing device according to claim 1 is characterized by having a plasma flow producing chamber for producing a plasma flow containing an object to be induced, a fullerene introducing portion which is disposed at the downstream side of the plasma flow producing chamber and introduces fullerene into the plasma flow, and an induction fullerene accumulating chamber having a recovering cylinder disposed so as to enclose a plasma flow at the downstream side of the fullerene introducing portion.

An induction fullerene producing device according to claim 19 is characterized by having a plasma flow producing chamber for producing a plasma flow containing an object to be induced, a high-temperature plasma flow forming chamber for forming a high-temperature plasma flow from the plasma flow, a fullerene introducing portion for introducing fullerene into the high-temperature plasma flow forming chamber, and an induction fullerene accumulating chamber having a recovering cylinder disposed so as to enclose a plasma flow at the downstream side of the high-temperature plasma flow forming chamber.

An induction fullerene producing method according to claim 26 is characterized by having a process of producing a plasma flow from an object to be induced and a process of producing induction fullerene by introducing fullerene into the plasma flow and accumulating the induction fullerene in a recovering cylinder disposed so as to enclose the plasma flow.

### EFFECT OF THE INVENTION

According to claims 1, 19 and 26, fullerene is introduced into a plasma flow of an object to be induced. The object to be induced and the fullerene interact with each other becoming ions of reverse polarities to each other. And a recovering cylinder is disposed at the downstream side of the fullerene introducing portion so as to come into contact with the plasma flow. Due to interaction, hetero fullerene in which some of carbon atoms of fullerene are replaced with an object to be induced, included fullerene in which an object to be induced has been inside a carbon cage, and the like are produced. These induction fullerenes are recovered with high yield by being deposited in said cylinder.

According to claims 2, 3 and 27, a high-temperature plasma flow is formed, into which fullerene is introduced. In the high-temperature plasma flow, an object to be induced is dissociated to become atomic ions, which interact with fullerene. Thus, induction fullerene such as induced atom-substitution hetero fullerene or induced atom-included fullerene is produced.

According to claims 5 and 6, an electron energy control means provided at the upstream side of a fullerene introducing portion controls the electron energy in a plasma flow. Negative fullerene ions are produced by a fact that electrons are bonded to fullerene introduced from the fullerene introducing portion by controlling the electron energy to 0.5 to 15 eV. And in claims 5 and 6, an object to be induced in a plasma flow is made to be positive ions. That is, since an object to be induced and fullerene have been made to be ions of reverse polarities to each other, they collide with each other by being attracted by an electric attraction and thereby they are ready to produce induction fullerene.

According to claims 16 and 23, a voltage of the same polarity as that of ions of an object to be induced is applied to a potential body provided on the tail end of a plasma flow. Due to this, a relative speed of ions of an object to be induced to fullerene in the plasma flow is reduced. A Coulomb's force generated between two kinds of ions makes them be liable to collide with each other through an electric attraction and thereby can improve the yield in production of induction fullerene.

According to claims 17 and 24, a voltage of reverse polarity to that of ions of an object to be induced is applied to a potential body provided on the tail end of a plasma flow. Ions of an object to be induced can be made to collide with fullerene ions at a high energy by accelerating the ions of the object to be induced in moving speed through applying a voltage of reverse polarity to the potential body. Therefore, it is possible to promote formation of included fullerene.

According to claims 18 and 25, pulse-shaped voltages of the same polarity as and the reverse polarity to that of ions of an object to be induced are applied to a potential body provided on the tail end of a plasma flow. When a voltage of the same polarity is applied, fullerene being ions of the reverse polarity adsorbs to the potential body. When the voltage applied to the potential body is changed over to the reverse polarity in this state, the object to be induced is attracted to the potential body. And the interaction of it with the fullerene adsorbed to the potential body produces induction fullerene.

According to claims 13 and 21, a plasma flow coming into an induction fullerene-introducing portion is deposited in order in a recovering cylinder being in contact with the plasma flow. That is, since a plasma flow in the accumulating portion is kept in a low-density state, the probability that the induction fullerene once produced repeats interaction in the plasma flow is made low. Accordingly, induction fullerene is obtained with high yield.

### BRIEF DESCRIPTION OF THE DRAWINGS

FIG. 1 is a sectional view of an induction fullerene-producing device according to a first embodiment of the present invention;

FIG. 2 is a graph obtained by performing a mass spectrometric analysis on things deposited in a recovering cylinder in FIG. 1;

FIG. 3 is a sectional view of an induction fullerene producing device according to a third embodiment of the present invention; and

FIG. 4 is a flowchart showing an induction fullerene producing method according to the present invention.

### EXPLANATION OF THE SYMBOLS

101: Microwave oscillator,
102: Gas introducing opening,
103: Electromagnet,
104: Line of magnetic force,
105: Grid,
106, 111: Voltage source,
107: Fullerene sublimating oven,
108: Sublimating cylinder,
109: Electromagnet,
110: Potential body,
112: Recovering cylinder,
301: Fullerene introducing opening

### BEST MODES FOR CARRYING OUT THE INVENTION

The present invention is described in detail below.

### (Induction Fullerene Producing Method)

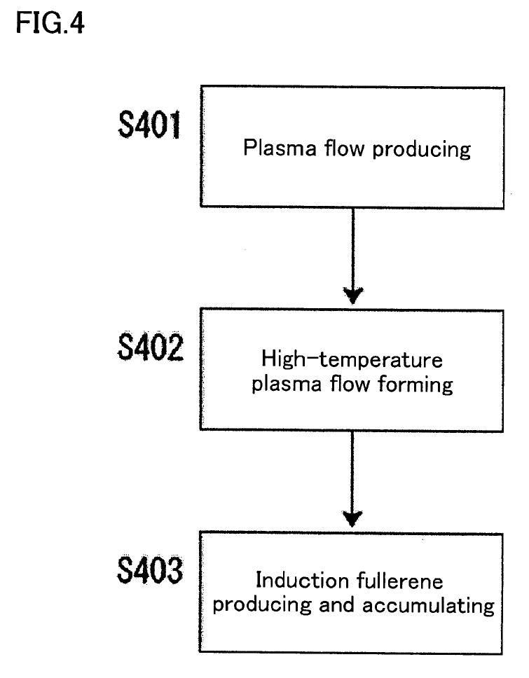

FIG. 4 shows a flowchart of a gas atom induction fullerene producing method according to the present invention.

First, this method produces a plasma flow in step S401. It makes a gas pass through a high-frequency coil, for example. At this time, the gas is ionized to produce a plasma flow. This gas includes molecules and atoms to be induced.

This method makes the plasma flow high in temperature in step S402. It constrains the plasma flow by generating lines of magnetic force at the input side and the output side of the plasma flow, for example. Further, it inputs microwave resonating with the rotational motion of electrons constrained by the lines of magnetic force into the constrained portion to make the plasma flow high in temperature by electron-cyclotron resonance heating. And by making the plasma flow high in temperature, an object to be induced is dissociated to become monatomic ions. This method introduces fullerene into the monatomic-ionized plasma flow in step S403. The introduced fullerene is ionized by electrons in the plasma flow. Since atomic ions of the object to be induced and the fullerene ions have become ions of reverse polarities to each other, they are attracted to and collide with each other by a Coulomb's force to produce induction fullerene. And the induction fullerene is deposited in order in a cylinder disposed so as to enclose the plasma flow.

In case that a sufficient amount of molecular or atomic ions of an object to be induced for producing induction fullerene are obtained in step S401, step S402 may be omitted.

### (Induction Fullerene Producing Device 1)

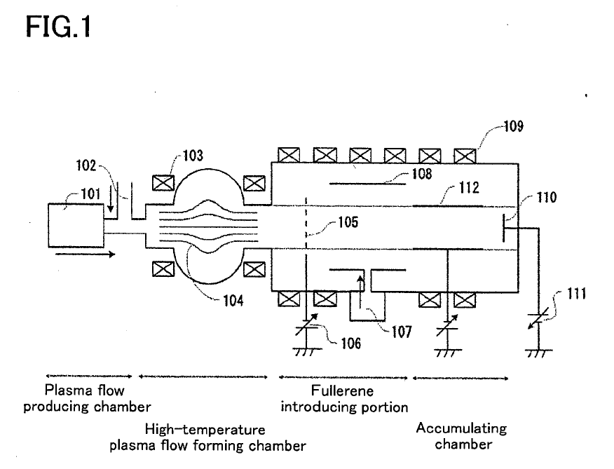

FIG. 1 shows a sectional view of an induction fullerene producing device according to a first embodiment of the present invention. This producing device is composed of a plasma flow producing chamber, a high-temperature plasma flow forming chamber, a fullerene introducing portion, and an induction fullerene accumulating chamber. A high-temperature plasma flow containing nitrogen gas is produced in the plasma flow producing chamber and the high-temperature plasma flow forming chamber. From the fullerene introducing portion, fullerene is introduced into a monatomic-ionized plasma flow. Due to that fact, this device produces hetero fullerene in which some of carbon atoms are replaced with nitrogen atoms or nitrogen molecules, nitrogen-included fullerene in which nitrogen atoms or nitrogen molecules have been inside carbon cages, and the like.

In the plasma flow producing chamber, microwave of 2.45 GHz for example is inputted from a microwave oscillator 101. And nitrogen gas is introduced through a gas introducing opening 102. Introduced nitrogen molecules are ionized by the microwave. And a plasma flow mainly consisting of nitrogen molecular ions N₂⁺ and electrons e⁻ is produced.

In the high-temperature plasma flow forming chamber, a pair of electromagnets 103 are disposed at each of the input side and the output side of a plasma flow. Lines of magnetic force 104 are produced by feeding a direct current to the electromagnets 103. Ions and electrons in the plasma flow fed from the plasma flow producing chamber move along the lines of magnetic force 104. And ions and electrons are raised in energy to form a high-temperature plasma flow by inputting microwave of 2.45 GHz, for example, resonating with the rotational motion of electrons from the oscillator 101. By forming a plasma flow of 10 to 50 eV, nitrogen molecules N₂, which have not been ionized, are dissociated to become monatomic atoms N and nitrogen-atomic ions N⁺. That is, a plasma flow consisting of nitrogen-molecular ions N₂⁺, nitrogen-atomic ions N⁺ and electrons e⁻ is formed in the high-temperature plasma flow forming chamber.

In the fullerene introducing portion, fullerene is introduced into a monatomic-ionized plasma flow. For example, fullerene is introduced by sublimating the fullerene from a fullerene sublimating oven 107. And a grid 105 is provided at the upstream side of the fullerene sublimating oven 107 and a negative voltage is applied to this grid 105 from a voltage source 106. Due to this, electrons in the plasma flow are lowered in energy. For example, by lowering electrons to 0.5 to 15 eV in energy, electrons bond to the sublimated fullerene in the fullerene sublimating oven 107 to produce negative fullerene ions C₆₀⁻. And a sublimating cylinder 108 is provided near the fullerene sublimating oven 107. The sublimating cylinder 108 is preferably heated to a temperature at which fullerene can be sublimated again. Fullerene, which has not been ionized in the plasma flow and has bonded to the sublimating cylinder 108 is sublimated again.

The induction fullerene accumulating chamber is composed of a recovering cylinder 112 and a potential body 110. The recovering cylinder 112 is arranged so as to come into contact with a plasma flow between the fullerene sublimating oven 107 and the potential body 110. By reducing the moving speed of monatomic nitrogen ions N⁺ through applying a positive voltage to the potential body 110 from a voltage source 111, their relative speed to fullerene ions C₆₀⁻ is reduced. At this time, a Coulomb's interaction between both ions becomes large and thereby attracts them to each other.

Electromagnets 109 may be disposed on the periphery of the fullerene introducing portion or the induction fullerene accumulating chamber. At this time a magnetic field in which lines of magnetic force are uniformly aligned toward the potential body 110 is generated and a plasma flow moves along this magnetic field.

It is preferable to design the radius of the recovering cylinder 112 so that it is within a range from R to R+2R_{L}. Here, R is the radius of a plasma flow outputted from the high-temperature plasma flow forming chamber, namely, the radius of a plasma flow when the electromagnets 109 are not operated. R_{L} is the Larmor radius of fullerene moving along a plasma flow when the electromagnets 109 are operated. That is, the radius of a plasma flow when the electromagnets 109 are operated is R+R_{L}.

Permanent magnets may be used instead of the electromagnets 109.

When the radius of the recovering cylinder 112 is made to be R+2R_{L}, fullerene ions C₆₀⁻ come into contact with the recovering cylinder 112. When the recovering cylinder 112 is grounded, the fullerene ions C60⁻ discharge electrons to become fullerene C₆₀ being electrically neutral and deposit. Nitrogen atomic ions N⁺, nitrogen atoms N which have become electrically neutral and the like come into contact with the deposited fullerene C₆₀. And hetero fullerene C₆₀₋ₓNₓ in which one or more carbon atoms have been replaced with nitrogen atoms is produced.

And fullerene ions C₆₀⁻ and nitrogen atomic ions N⁺ moving along a plasma flow collide with each other by being attracted to each other by a Coulomb's force to produce hetero fullerene C₆₀₋ₓNₓ. This also deposit in the recovering cylinder 112. In order to raise nitrogen atomic ions N⁺ in energy, said nitrogen atomic ions N⁺ being to collide with fullerene ions C60⁻ moving near the recovering cylinder 112, a negative voltage of −10 to −50V for example may be applied to the recovering cylinder 112.

A Larmor radius R_{L} is in inverse proportion to a magnetic field strength. For example, it is possible to estimate the Larmor radius of fullerene as R_{L} □0.4 mm under the condition that B=0.3 T and the plasma temperature is 800□.

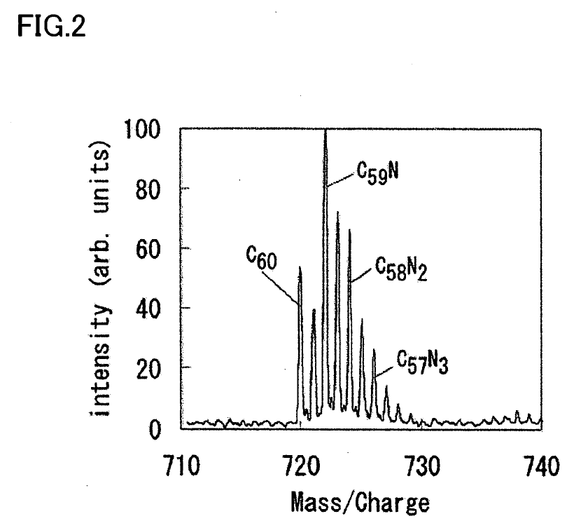

FIG. 2 shows a graph obtained by performing a mass spectrometric analysis on things deposited in the recovering cylinder 112. This is a result of performing a mass spectrometric analysis on things precipitated at the time of dissolving things deposited in the recovering cylinder 112 in toluene or carbon disulfide. The abscissa represents a mass number included in one molecule and the ordinate represents the intensity detected.

A mass number corresponding to hetero fullerene C₅₉N in which one of carbon atoms is replaced with a nitrogen atom is 722 and there is the highest peak at 721.97 being in the vicinity of it. And there is a peak at 721.00 and it is thought that this is caused by a fact that one of carbon atoms forming fullerene C₆₀ is replaced with an isotope having a mass number of 13.

The ratio of the numbers of atoms of carbon isotopes having mass numbers of 12 and 13, which exist, in the natural world is 0.9893:0.0107. There are also a little carbon atoms having a mass number of 14, but their ratio is negligible. Table 1 is obtained by computing the ratio of the numbers of molecules of fullerene C₆₀ isotopes being different in mass number on the basis of the ratio of the numbers of atoms of carbon isotopes being 12 and 13 in mass number. Here, this table shows the ratios when the number of molecules being 720 in mass number is assumed to be 1.0.

TABLE 1
Ratio of the numbers of molecules of fullerene C₆₀ isotopes

| 1: Mass number | 2: Ratio of the numbers of molecules |
|---|---|
| 720 | 1.0 |
| 721 | 0.649 |
| 722 | 0.207 |
| 723 | 0.043 |
| 724 | 0.007 |

There are isotopes of 13 and 14 in mass number for nitrogen atom also, but the ratio of the numbers of atoms of them is 1.0e-5:0.99999 and the isotope being 13 in mass number is negligible. Table 2 and Table 3 are obtained respectively by computing the ratios of the numbers of molecules of hetero fullerenes C₅₉N and C₅₈N₂ isotopes being different in mass number on the basis of the ratio of the numbers of atoms of carbon isotopes being 12 and 13 in mass number. These tables show the ratios when the numbers of molecules of C₅₉N being 722 in mass number and C₅₈N₂ being 724 in mass number are respectively assumed to be 1.0.

TABLE 2
Ratio of the numbers of molecules of fullerene C₅₉N isotopes

| 1: Mass number | 2: Ratio of the numbers of molecules |
|---|---|
| 722 | 1.0 |
| 723 | 0.638 |
| 724 | 0.2001 |
| 725 | 0.041 |
| 726 | 0.006 |

TABLE 3
Ratio of the numbers of molecules of fullerene C₅₈N₂ isotopes

| 1: Mass number | 2: Ratio of the numbers of molecules |
|---|---|
| 724 | 1.0 |
| 725 | 0.627 |
| 726 | 0.193 |

Table 4 shows a result of performing compensation on the graph of mass spectrometric analysis of FIG. 2.

TABLE 4
Compensation of measured intensities
in consideration of isotope molecules

| | Corresponding | | |
|---|---|---|---|
| | molecules | | Intensity |
| Measured | (Corresponding | Measured | after |
| mass number | mass number) | intensity | compensation |
| 720.00 | C₆₀(720) | 53.92 | — |
| 721.97 | C₅₉N(722) | 100.00 | 88.84 |
| 723.97 | C₅₈N₂(724) | 66.45 | 48.31 |
| 726.02 | C₅₇N₃(726) | 26.20 | 16.30 |

For example, measured intensities of C₅₉N and C₅₈N₂ are compensated respectively as shown in expression 1 and expression 2.

Compensation of measured intensity of C₅₉N

Measured intensity of C₅₉N−measured intensity of C₆₀×ratio of numbers of molecules in mass number of 722 of C₆₀=100.00−53.92×0.207=88.84 (Expression 1)

Compensation of measured intensity of C₈₅N₂

Measured intensity of C₅₈N₂−measured intensity of C₆₀×ratio of numbers of molecules in mass number of 724 of C₆₀−measured intensity of C₅₉N after compensation of C₅₉N×ratio of numbers of molecules in mass number of 724 of C₅₉N=66.45−53.92×0.007−88.84×0.2001=48.31 (Expression 2)

That is, even when the intensity depending on each isotope is subtracted from each measured intensity, large peaks remain at 721.97, 723.97 and 726.02. These peaks correspond to hetero fullerenes C₅₉N, C₅₈N₂ and C₅₇N₃ being 722, 724 and 726 in mass number, respectively. It is understood that hetero fullerene in which a plurality of carbon atoms are replaced with nitrogen atoms has been formed.

An X-ray photoelectron spectroscopic analysis has been performed on things deposited in the recovering cylinder 112. The result of measurement of it has been the sum of signal intensities corresponding to bond energies between carbon atoms, between the SP² orbit of a carbon atom and a nitrogen atom, and between the SP³ orbit of a carbon atom and a nitrogen atom. That is, it is understood that a molecule composed of carbon atoms and nitrogen atoms has been produced.

In case of producing boron atom-induction fullerene and hydrogen atom-induction fullerene, it is enough to introduce gases containing the respective atoms such as a boron fluoride gas BF₃ and a hydrogen gas H₂ through the gas introducing opening 102.

There is also a method of increasing the collision energy between fullerene ions and nitrogen ions in order to promote generation of included fullerene. For this, the collision energy may be increased by accelerating nitrogen ions in moving speed through applying a negative voltage of −30V for example to the potential body 110.

In case of introducing a gas containing boron atoms, boron ions B³⁺ are produced in the high-temperature plasma forming chamber. These ions come into contact with fullerene deposited in the recovering cylinder 112 or are attracted to and collide with fullerene ions moving along a plasma flow. And hetero fullerene in which some of carbon atoms are replaced with boron atoms or boron molecules, included fullerene in which a boron atom or a boron molecule has been inside a carbon cage, and the like are produced.

In case of introducing a gas containing hydrogen atoms, hydrogen ions H⁺ are produced in the high-temperature plasma forming chamber. These ions come into contact with fullerene deposited in the recovering cylinder 112 or are attracted to and collide with fullerene ions moving along a plasma flow. And hydride fullerene in which hydrogen atoms bond to some of carbon atoms, included fullerene in which a hydrogen atom or a hydrogen molecule has been inside a carbon cage, and the like are produced.

In case of producing halogen atom-induction fullerene, it is enough to introduce a gas containing halogen atoms through the gas introducing opening 102. For example, in case of producing fluorine atom-induction fullerene, carbon tetrafluoride CF₄ is used. Carbon tetrafluoride CF₄ is ionized into two ions CF₃⁺ and F⁻ and a high-temperature plasma flow is formed in the high-temperature plasma flow forming chamber. In case of producing halogen atom-induction fullerene, the grid 105 is made to be in a floating state. And a relative speed between halogen atoms and fullerene is reduced by applying a negative voltage to the potential body 110. At this time, electrons discharged from a high-temperature plasma flow collide with fullerene sublimated in the fullerene sublimating oven 107 as they are kept at a high energy of 10 to 50 eV. And positive fullerene ions C₆₀⁺ are produced by discharging electrons from the fullerene.

In case that the recovering cylinder 112 is grounded, the fullerene ions C₆₀⁺ become fullerene C₆₀ being electrically neutral and deposit when the fullerene ions C₆₀⁺ come into contact with the recovering cylinder 112. Fluoride atomic ions F⁻, fluorine atoms F which have become electrically neutral, and the like come into contact with the deposited fullerene C₆₀. And induction fullerene such as fluoride fullerene in which fluorine has bonded to some of carbon atoms, fluorine-included fullerene in which fluorine has been inside a carbon cage, of the like is produced.

And fullerene ions C₆₀⁺ and fluorine ions F⁻ moving along a plasma flow collide with each other by being attracted to each other by a Coulomb's force to produce induction fullerene, which deposits in the recovering cylinder 112. In order to raise fluorine ions F⁻ in energy, said fluorine ions F⁻ being to collide with fullerene ions C60⁺ moving near the recovering cylinder 112, appositive voltage may be applied to the recovering cylinder 112.

It is preferable to cool the recovering cylinder 112 during producing induction fullerene. For example, it is cooled by flowing water through a cooling water pipe wound around the outer circumference of the recovering cylinder 112. It is preferable to cool it to 200□ or lower. Particularly, it is preferable to cool it to 100□ or lower. By cooling the recovering cylinder 112, it is possible to prevent fullerene from being sublimated again and thereby reduces the amount of fullerene not recovered.

### (Induction Fullerene Producing Device 2)

In FIG. 1, the recovering cylinder 112 may be extended to the vicinity of the potential body 110. Ions also collide with each other in the vicinity of the potential body 110. Ions which are low in relative speed and reverse in polarity to each other are also generated by repeating collision. These ions collide with each other by being attracted to each other by a Coulomb's interaction between them and thus hetero fullerene, included fullerene and the like are produced. When they were produced applying a voltage of −20V or −40V to the potential body 110, a great amount of hetero fullerenes C₅₉N, C₅₈N₂, C₅₇N₃, etc. were detected in the recovering cylinder 112 in the vicinity of the potential body 110. A positive voltage and a negative voltage may be alternately applied to the potential body 110. When a positive voltage is applied, fullerene being negative ions adsorbs to the potential body 110. When in this state a changeover is performed so as to apply a negative voltage to the potential body 110, nitrogen molecular ions N₂⁺ and nitrogen atomic ions N⁺ are attracted. And they interact with fullerene adsorbed to the potential body 110 and thereby induction fullerene is produced.

It is preferable to apply a negative voltage being reverse in polarity to nitrogen ions for a long time in this case. That is, the time for which nitrogen ions are pouring on and interacting with the fullerene adsorbed to the potential body 110 is made long, and thereby it is possible to improve the yield of induction fullerene.

At the time of applying a negative voltage, it is preferable to apply a rather high voltage. Applying a rather high voltage makes the accelerated high-energy nitrogen ions collide with fullerene and thereby can promote inclusion. And due to reaction by acceleration, induction fullerene, fullerene not reacted and the like which are adsorbed to the potential body 110 peel and fall off, and are recovered by the recovering cylinder 112.

In the first embodiment and the second embodiment, the high-temperature plasma flow forming chamber does not need to be provided in case of being able to obtain a sufficient amount of molecular or atomic ions of an object to be induced for producing induction fullerene in the plasma flow producing chamber.

And the plasma flow producing chamber is not limited to that of FIG. 1. Plasma of an object to be induced may be produced using a high-frequency induction coil. And in case of producing induction fullerene from alkali metals, plasma may be generated by spraying alkali metal vapor against a high-temperature metal plate. This is the same also in embodiment 3 and embodiment 4 described below.

### (Induction Fullerene Producing Device)

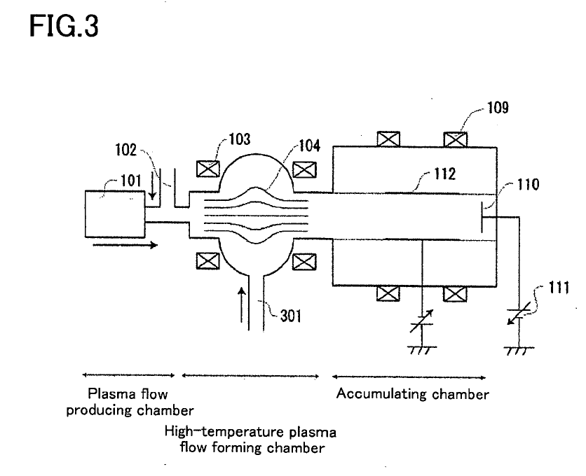

FIG. 3 shows a sectional view of an induction fullerene-producing device according to a third embodiment of the present invention. The same components as those of FIG. 1 are designated by the same symbols.

This embodiment introduces fullerene through a fullerene introducing opening 301 into a high-temperature plasma flow forming chamber. The fullerene repeats collision with electrons to be ionized in the high-temperature plasma flow forming chamber. The ionized fullerene moves along a plasma flow and deposits in a recovering cylinder 112. Ions of an object to be induced, neutral atoms and the like collide with the deposited fullerene to produce induction fullerene such as hetero fullerene and included fullerene. And ions of an object to be induced collide with fullerene ions moving along a plasma flow and thereby induction fullerene is produced and deposits in the recovering cylinder 112.

In case of producing induction fullerene by attracting fullerene ions and ions of an object to be included to each other by a Coulomb's force in a similar manner to embodiment 1, a voltage of the same polarity as ions of an object to be induced is applied to a potential body 110. In case of promoting generation of included fullerene by increasing the collision energy, a voltage of reverse polarity to ions of an object to be included is applied to the potential body 110.

### (Induction Fullerene Producing Device 4)

In FIG. 3 also, the recovering cylinder 112 may be extended to the vicinity of the potential body 110. In this case also, induction fullerene is produced by a fact that some of fullerene ions and ions of an object to be induced repeat collision with each other flying to the vicinity of the potential body 110.

In the same manner as embodiment 2, a positive voltage and a negative voltage may be alternately applied to the potential body 110. Due to this, it is possible to produce induction fullerene over the potential body 110 and recover it in the recovering cylinder 112.

In case of producing nitrogen atom/molecule-substitution hetero fullerene or nitrogen atom/molecule-included fullerene in each of the above-mentioned embodiments, a mixed gas of nitrogen and inert gas may be introduced through a gas introducing opening 102.

### INDUSTRIAL APPLICABILITY

According to claims 1, 19 and 26, fullerene is introduced into a plasma flow of an object to be induced. The object to be induced and the fullerene interact with each other becoming ions of reverse polarities to each other. And a recovering cylinder is disposed at the downstream side of the fullerene-introducing portion so as to come into contact with the plasma flow. Due to interaction, hetero fullerene in which some of carbon atoms of fullerene are replaced with an object to be induced, included fullerene in which an object to be induced has been inside a carbon cage, and the like are produced. These induction fullerenes are recovered with high yield by being deposited in said cylinder.

According to claims 2, 3 and 27, a high-temperature plasma flow is formed, into which fullerene is introduced. In the high-temperature plasma flow, an object to be induced is dissociated to become atomic ions, which interact with fullerene. Thus, induction fullerene such as induced atom-substitution hetero fullerene or induced atom-included fullerene is produced.

According to claims 5 and 6, an electron energy control means provided at the upstream side of a fullerene introducing portion controls the electron energy in a plasma flow. Negative fullerene ions are produced by a fact that electrons are bonded to fullerene introduced from the fullerene introducing portion by controlling the electron energy to 0.5 to 15 eV. And in claims 5 and 6, an object to be induced in a plasma flow is made to be positive ions. That is, since an object to be induced and fullerene have been made to be ions of reverse polarities to each other, they collide with each other by being attracted by an electric attraction and thereby they are ready to produce induction fullerene.

According to claims 16 and 23, a voltage of the same polarity as that of ions of an object to be induced is applied to a potential body provided on the tail end of a plasma flow. Due to this, a relative speed of ions of an object to be induced to fullerene in the plasma flow is reduced. A Coulomb's force generated between two kinds of ions makes them be liable to collide with each other through an electric attraction and thereby can improve the yield in production of induction fullerene.

According to claims 17 and 24, a voltage of reverse polarity to that of ions of an object to be induced is applied to a potential body provided on the tail end of a plasma flow. Ions of an object to be induced can be made to collide with fullerene ions at a high energy by accelerating the ions of the object to be induced in moving speed through applying a voltage of reverse polarity to the potential body. Therefore, it is possible to promote formation of included fullerene.

According to claims 18 and 25, pulse-shaped voltages of the same polarity as and the reverse polarity to that of ions of an object to be induced are applied to a potential body provided on the tail end of a plasma flow. When a voltage of the same polarity is applied, fullerene being ions of the reverse polarity adsorbs to the potential body. When the voltage applied to the potential body is changed over to the reverse polarity in this state, the object to be induced is attracted to the potential body. And the interaction of it with the fullerene adsorbed to the potential body produces induction fullerene.

According to claims 13 and 21, a plasma flow coming into an induction fullerene-introducing portion is deposited in order in a recovering cylinder being in contact with the plasma flow. That is, since a plasma flow in the accumulating portion is kept in a low-density state, the probability that the induction fullerene once produced repeats interaction in the plasma flow is made low. Accordingly, induction fullerene is obtained with high yield.

1. An induction fullerene producing device, characterized by having a plasma flow producing chamber for producing a plasma flow containing an object to be induced, a fullerene introducing portion which is disposed at the downstream side of said plasma flow producing chamber and introduces fullerene into a plasma flow, and an induction fullerene accumulating chamber having a recovering cylinder disposed so as to enclose a plasma flow at the downstream side of said fullerene introducing portion.

2. The induction fullerene producing device according to claim 1, characterized by having a high-temperature plasma flow forming chamber for forming a high-temperature plasma flow from a plasma flow generated in the plasma producing chamber.

3. The induction fullerene producing device according to claim 2, characterized in that a high-temperature plasma flow of 10 to 50 eV in electron energy is produced in said high-temperature plasma flow forming chamber.

4. The induction fullerene producing device according to claim 1, characterized in that a plasma flow containing positive ions of an object to be induced and electrons is formed in said plasma flow producing chamber or said high-temperature plasma flow forming chamber.

5. The induction fullerene producing device according to claim 4, characterized in that an electron energy control means is provided at the upstream side of said fullerene introducing portion and negative fullerene ions are formed by a fact that energy-controlled electrons bond to fullerene introduced from the fullerene introducing portion.

6. The induction fullerene producing device according to claim 5, characterized in that said electron energy control means controls the energy of electrons to 0.5 to 15 eV.

7. The induction fullerene producing device according to claim 4, characterized in that said object to be induced is a nitrogen gas or a boron compound gas, and gas molecule-substitution fullerene, gas atom-substitution hetero fullerene, gas molecule-included fullerene and gas atom-included fullerene are produced.

8. The induction fullerene producing device according to claim 4, characterized in that said object to be induced is a hydrogen gas, and hydride fullerene, hydrogen molecule-included fullerene and hydrogen atom-included fullerene are produced.

9. The induction fullerene producing device according to claim 1, characterized in that a plasma flow containing negative ions of an object to be induced is formed in said plasma flow producing chamber or said high-temperature plasma flow forming chamber.

10. The induction fullerene producing device according to claim 9, characterized in that electrons are discharged and positive fullerene ions are formed by a fact that electrons in a high-temperature plasma flow collide with fullerene introduced from the fullerene introducing portion.

11. The induction fullerene producing device according to claim 9, characterized in that aid object to be induced is halogen, and halide fullerene, halogen molecule-included fullerene and halogen atom-included fullerene are produced.

12. The induction fullerene producing device according to claim 1, characterized in that said induction fullerene accumulating chamber has a potential body disposed at the tail end of a plasma flow and said recovering cylinder which is disposed between said fullerene introducing portion and said potential body and comes into contact with a plasma flow.

13. The induction fullerene producing device according to claim 12, characterized in that said fullerene introducing portion or said induction fullerene accumulating chamber has a magnetic field generating means, and the radius of said recovering cylinder is between R and R+2R_{L} on the assumption that the radius of a plasma flow when a magnetic field is not generated is R and the Larmor radius of fullerene in a plasma flow when a magnetic field is generated is R_{L}.

14. The induction fullerene-producing device according to claim 12, characterized in that said recovering cylinder is grounded.

15. The induction fullerene-producing device according to claim 12, characterized in that said recovering cylinder is disposed also near said potential body.

16. The induction fullerene-producing device according to claim 12, characterized in that a voltage of the same polarity as ions of an object to be induced in a plasma flow is applied to said potential body.

17. The induction fullerene-producing device according to claim 12, characterized in that a voltage of reverse polarity to ions of an object to be induced in a plasma flow is applied to said potential body.

18. The induction fullerene producing device according to claim 12, characterized in that a pulse-shaped voltage composed of a positive voltage and a negative voltage is applied to said potential body.

19. An induction fullerene producing device, characterized by having a plasma flow producing chamber for producing a plasma flow containing an object to be induced, a high-temperature plasma flow forming chamber for forming a high-temperature plasma flow from said plasma flow, a fullerene introducing portion for introducing fullerene into said high-temperature plasma flow forming chamber, and an induction fullerene accumulating chamber having a recovering cylinder disposed so as to enclose a plasma flow at the downstream side of said high-temperature plasma flow forming chamber.

20. The induction fullerene producing device according to claim 19, characterized in that said induction fullerene accumulating chamber has a potential body disposed at the tail end of a plasma flow and said recovering cylinder which is disposed between said fullerene introducing portion and said potential body and comes into contact with a plasma flow.

21. The induction fullerene producing device according to claim 20, characterized in that said induction fullerene accumulating chamber has a magnetic field generating means, and the radius of said recovering cylinder is between R and R+2R_{L} on the assumption that the radius of a plasma flow when a magnetic field is not generated is R and the Larmor radius of fullerene in a plasma flow when a magnetic field is generated is R_{L}.

22. An induction fullerene-producing device according to claim 19, characterized in that said recovering cylinder is disposed also near said potential body.

23. The induction fullerene-producing device according to claim 19, characterized in that a voltage of the same polarity as ions of an object to be induced in a plasma flow is applied to said potential body.

24. The induction fullerene-producing device according to claim 19, characterized in that a voltage of reverse polarity to ions of an object to be induced in a plasma flow is applied to said potential body.

25. The induction fullerene producing device according to claim 19, characterized in that a pulse-shaped voltage composed of a positive voltage and a negative voltage is applied to said potential body.

26. An induction fullerene producing method, characterized by having a process of producing a plasma flow from an object to be induced and a process of producing induction fullerene by introducing fullerene into said plasma flow and accumulating said induction fullerene in a recovering cylinder disposed so as to enclose the plasma flow.

27. The induction fullerene producing method according to claim 26, characterized by having a process of forming a high-temperature plasma flow from a generated plasma flow and introducing fullerene into said high-temperature plasma flow.

28. The induction fullerene producing method according to claim 26, characterized in that said object to be induced is a nitrogen gas or a boron compound gas, and gas molecule-substitution hetero fullerene, gas atom-substitution hetero fullerene, gas molecule-included fullerene and gas atom-included fullerene are produced.

29. The induction fullerene producing method according to claim 26, characterized in that said object to be induced is hydrogen gas, and hydride fullerene, hydrogen molecule-included fullerene and hydrogen atom-included fullerene are produced.

30. The induction fullerene producing method according to claim 28, characterized by generating negative fullerene ions through making energy-controlled electrons collide with fullerene introduced into said plasma flow.

31. The induction fullerene producing method according to claim 30, characterized by controlling electron energy in said plasma flow to 0.5 to 15 eV.

32. The induction fullerene producing method according to claim 26, characterized in that said object to be induced is halogen, and halide fullerene, halogen molecule-included fullerene and halogen atom-included fullerene are produced.

33. The induction fullerene producing device according to claim 32, characterized in that electrons are discharged and positive fullerene ions are formed by a fact that electrons in a high-temperature plasma flow collide with fullerene introduced into said high-temperature plasma flow.

34. Induction fullerene, characterized by being produced by a method according to claim 26.

35. The induction fullerene according to claim 34, characterized in that said induction fullerene is hetero fullerene in which one or more carbon atoms are replaced with nitrogen atoms.
